(19) United States
(12) Patent Application Publication
(10) Pub. No.: US 2001/0043973 A1
(43) Pub. Date: Nov. 22, 2001

(54) Hard shell baking cups

(76) Inventors: Friedrich Keck, Brookpark, OH (US); Mary Ellen Bell, Brook Park, OH (US)

Correspondence Address: John M. Skeriotis, Fourteenth Floor, One Cascade Plaza, Akron, OH, 44308, US

(21) Appl. No.: 09/902,251

(22) Filed: Jul. 10, 2001

Related U.S. Application Data
(63) Continuation-in-part of application No. 09/374,922, filed on Aug. 16, 1999.

(51) Int. Cl. A21D 13/00

(52) U.S. Cl. 426/138

(57) ABSTRACT

An consumable baking cup for retaining muffin batter during the baking process includes a generally planar base and a continuous upwardly extending side wall. The consumable baking cup will be used in place of a paper or foil liner in a traditional muffin-baking pan. Alternately, the baking cup can be used in a “stand-alone” manner on top of a rigid baking sheet. One embodiment of the baking cup will be utilized for muffin batters. An alternative embodiment of the consumable baking cup for use with more liquid cupcake batter is also provided. The consumable baking cup does not require removal from the baked muffin or cupcake before consumption thereof.

### BACKGROUND OF THE INVENTION

This is a application claiming priority from a utility patent application, which is incorporated herein by reference. The utility patent application has Ser. No. 09/374,922, and was filed on Aug. 16, 1999. Inventorship remains the same.

1. Field of Invention

This invention relates generally to the art of baking cups for muffins, cupcakes and the like and more particularly to providing a consumable baking cup and methods of producing a baked food item/consumable baking cup combination.

2. Description of the Related Art

Traditionally, muffins, cupcakes, and the like are baked from a fairly viscous batter that is poured into a baking pan having separate cup-like cavities. Each cavity may be coated in cooking oil or shortening to allow ready release of the food item from the baking pan after the batter is baked. However, inconsistent results can occur such as stuck baked goods and messy clean-up jobs. Also, it is not convenient to manually hold baked goods made this way because of the oil used in the muffin baking pan or sticky ingredients included in the batter.

Alternately, each cavity may be lined with paper or foil baking cups before addition of the batter. After baking, the baked food item is removed from the cavity with the baking cup retained thereon. In order to consume the baked food item, one must first peel off the liner. The use of a baking cup liner not only inconveniences the consumer, but often much of the food product itself is pulled away with the liner yielding unfavorable results.

It is known in the art to fill traditionally shaped ice cream cups with cupcake batter to form a dessert item. U.S. Pat. Nos. 5,450,785 and 5,899,353 describe various holders for supporting ice cream cups filled with cupcake batter during a baking process. Neither patent provides for an edible baking cup to be used in a traditional muffin baking pan and these patents actually teach away from using an edible baking cup in a stand-alone manner.

The present invention is directed to a consumable baking cup that overcomes the aforementioned difficulties and more, in a way, which is simple and economical.

### SUMMARY OF THE INVENTION

In accordance with the present invention, a baking cup is provided for containing viscous batter during a baking process in which the viscous batter forms a baked food item. The baking cup comprises a generally planar base and a continuous upwardly extending side wall having an upper edge and defining a the container for receiving said viscous batter.

According to a further aspect of the invention, the base of the baking cup is circular and the side wall is outwardly angled from the base at an angle α wherein the defined interior space generally increases in circular cross section from the base to an upper region of the side wall.

According to yet another aspect of the invention, the baking cup further comprises a (tapered) reinforcing structure of approximately from ⅜″ at the top edge of the baking cup.

According to another aspect of the invention, the stacking structure includes a plurality of partial walls.

According to another aspect of the invention, the side wall of the baking cup exhibits a first thickness T₁ from the base to an upper region and a second thickness T₂ in the upper region, wherein T₂ is greater than T₁, wherein T₂ is located at the top ⅜″ of the baking cup.

According to another aspect of the invention, a process for preparing a baked food item in a consumable baking cup is provided. The process includes the steps of forming a pre-baked consumable baking cup having a generally planar base and a continuous upwardly extending side wall having an upper edge and defining the inside space of the baking cup; filling the baking cup with a viscous batter; and, baking said batter to form a baked food item.

According to another aspect of the invention, the step of forming the pre-baked consumable baking cup includes the steps of preparing a mixture of ingredients suitable for the type of batter to be utilized; molding the mixture; and pre-baking the molded mixture to form the baking cup.

According to another aspect of the invention, the process further includes the step of re-baking the pre-baked container during the step of baking the batter.

According to another aspect of the invention, the process further includes the step of placing the pre-baked baking cup into a cavity of an associated muffin-baking pan before the step of filling the baking cup with batter.

According to another aspect of the invention, the process further includes the step of placing the pre-baked baking cup onto a flat baking sheet before the step of filling the baking cup whereby the baking cup is used in a “stand-alone” manner.

According to another aspect of the invention, a baked food item/consumable baking cup combination is provided wherein the baked food item is formed of baked muffin batter and the baking cup includes a generally planar base and a continuous upwardly extending side wall.

One advantage of the present invention is that the baking cup is consumable which eliminates the problems associated with a foil or paper liner.

Another advantage of the present invention is that the baking cup may be utilized in conventional muffin baking pans, eliminating the need for users to purchase specialized baking equipment.

Another advantage of the present invention is that the baking cup may be used in a stand-alone manner without a conventional muffin-baking pan.

Another advantage of the present invention is that the baking cup provides a barrier between sticky ingredients in the baked food item and a person's hand.

Another advantage of the present invention is that one embodiment can be used for a thicker batter such as muffin batter, and another embodiment can be used for a more liquid-like batter such as cupcake batters in order to compensate for differences therein.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a front sectional view of one embodiment of the present invention showing the side wall having a uniform thickness;

FIG. 2 is a front view, partly in section, of an alternate embodiment of the present invention showing the side wall having a greater thickness in an upper region;

FIG. 3 is a top sectional view taken along the line 3-3 of FIG. 2 showing a preferred reinforcing structure in the present invention;

FIG. 4 is a perspective view of a food product/edible baking cup combination;

FIG. 5 is a cross-sectional view of a second embodiment of the present invention;

FIG. 6 is an enlarged fragmentary view of the second embodiment of the present invention; and,

FIG. 7 is a top view of the second embodiment of the present invention; and,

FIG. 8 is a cross-sectional view of a plurality of baking cups in accordance with the second embodiment of the present invention.

### DESCRIPTION OF THE PREFERRED EMBODIMENT

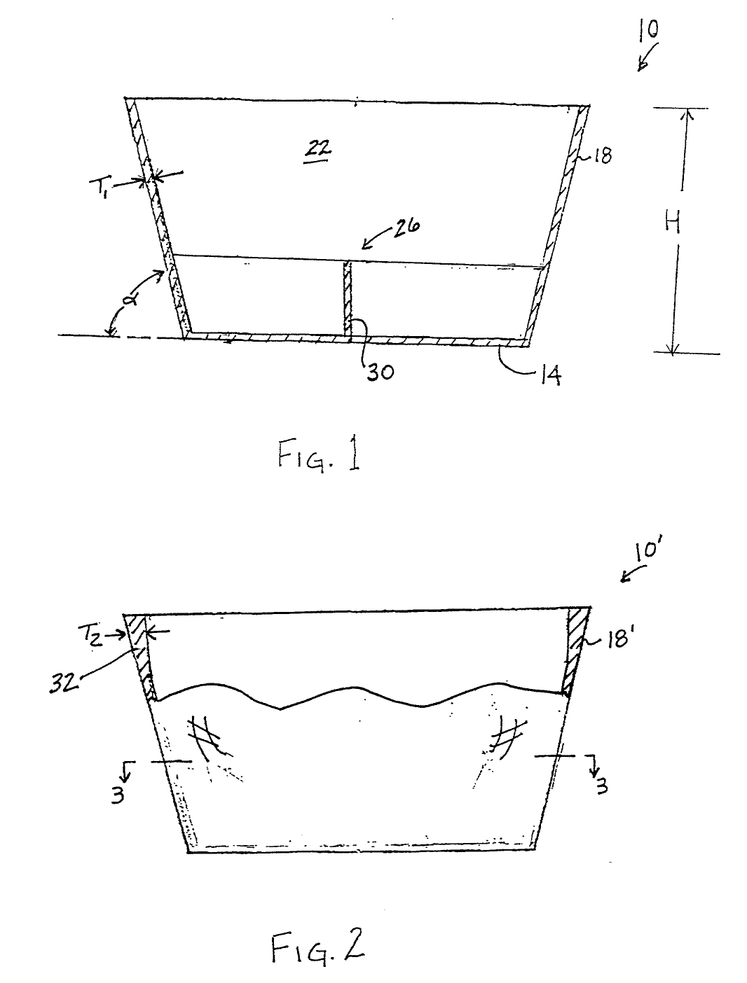

Referring now to the drawings wherein the showings are for purposes of illustrating a preferred embodiment of the invention only and not for purposes of limiting the same, FIG. 1 shows a front sectional view of one embodiment of an edible baking cup 10 according to the invention. In this preferred embodiment, the baking cup 10 includes a base 14 and a continuous upwardly extending side wall 18 which define an interior space 22 being open at the top for reception of muffin or cupcake batter, or other fairly viscous batter which may be baked to form a food item (not shown in this view). The side wall 18 is disposed at an outside angle α relative to the base 14 wherein 45°≦α≦90°. The baking cup 10 is preferably adapted to be used in association with conventional muffin baking pans. Therefore, a sloped side wall 18 is preferable to a vertical side wall 18 in order for the baking cup 10 to fit into the cavity of a conventional muffin-baking pan.

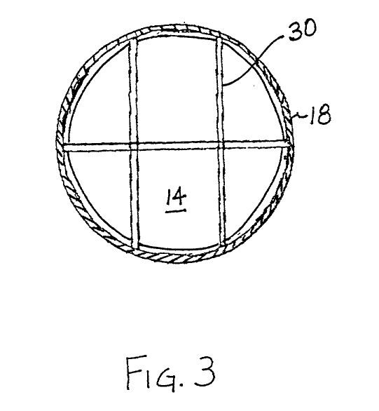

With particular reference to FIGS. 1 and 3, the preferred embodiment of the baking cup 10 further includes a stacking structure 26. The preferred stacking structure 26 includes a plurality of partial walls 30 that extend from the base 14. The stacking structure 26 permits stacking of the baking cups 10 during storage and transit while protecting the side wall 18 from damage and allowing ready separation of adjacent baking cups 10. Also, because the baking cup 10 may be utilized in a stand-alone fashion without a conventional muffin pan, the stacking structure 26 provides additional support during the baking process. The preferred stacking structure 26 is shown in FIG. 3 and includes a grid-like pattern although other arrangements of the partial walls 30 are within the scope of the present invention.

The baking cups 10 are preferably formed in a variety of sizes to conform to conventional muffin baking pans. For example, “mini” baking cups 10 are usually ¾″ to 1″ in height, H, and are 1⅝″ in diameter at the upper opening and 1¼″ in diameter at base 14. “Standard” baking cups 10 are generally 1¼″ in height, H, 2¾″ in diameter at the upper opening, and 2″ in diameter at the base 14. “Large” baking cups 10 may be 2″ in height, H, 3¾″ in diameter at the upper opening, and 2¾″ in diameter at the base 14. It is within the scope of the present invention to provide baking cups 10 having other proportions than the ones listed above without departing from the scope of the invention. In the preferred embodiment, the stacking structure 26 extends to approximately 30% to 50% of the overall height, H, of the baking cup 10.

Also, in the preferred embodiment, the side wall 18 has a thickness, T₁, of approximately 5/64″, and the partial walls 30 each have a thickness of approximately 1/16″. As shown in FIG. 1, side wall 18 is of generally uniform thickness, T₁i. The baking cup 10′ shown in FIG. 2, is similar to that shown in FIG. 1 except that side wall 18′ includes an upper region 32 that has a thickness, T₂, which is greater than T₁, in order to reinforce the upper edge 38 of the baking cup. In the preferred embodiment, T₂ is at least 50% greater than T₁I.

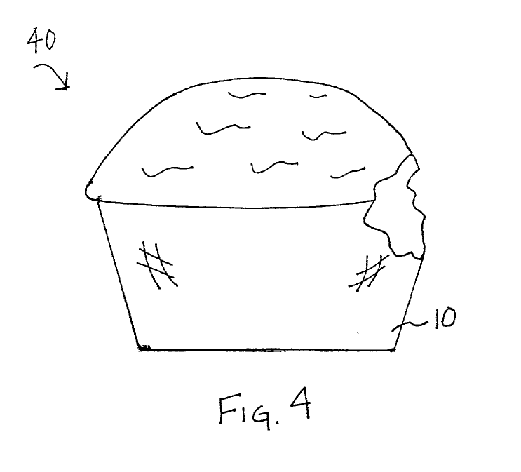

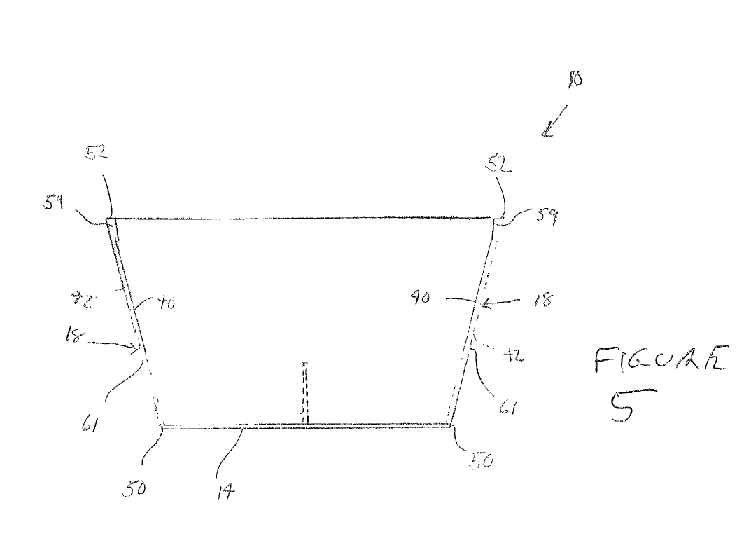

The baking cup 10 of the present invention may be used in a manner similar to a conventional paper liner. Firstly, a pre-baked baking cup 10 is inserted into each cavity of a typical muffin-baking pan. Secondly, a prepared batter is poured into the baking cups 10 to fill them approximately three-quarters full. The baking pan is then inserted into a pre-heated oven and baked at an appropriate temperature for an appropriate time until the batter forms a baked food item. During this step, the baking cup 10 undergoes a re-baking process. After the muffin pan and its contents are cooled, the baked item/baking cup combination 40 may be removed from the muffin-baking pan by inversion of the pan or by simply vertically lifting the baking cup. As shown in FIG. 4, as opposed to the paper liners, the baking cup 10 of the present invention is not removed from the baked food item before consumption. If a prepared topping or frosting is desired, it way be spread onto the baked food item before consumption.

The baking cup 10 of the present invention may also be used as a “stand-alone” container for the batter during a baking process. The pre-baked baking cup 10 is placed onto a flat baking sheet and filled with the appropriate batter. The baking sheet is then placed into an oven at a predetermined temperature for a predetermined time. The baking cup/baked food item combination 40 is then cooled on the baking sheet before consumption. This process eliminates the need for the step of removing the baking cup/baked food item combination 40 from a muffin-baking pan.

The composition of the baking cup 10 is preferably varied according to the type of batter to be baked therein. For example, baking cups 10 formed from a first composition are preferably used when baking muffins and baking cups 10 formed from a second composition are preferably used when baking cupcakes.

Example 1

Composition of Baking Cups for Muffins

Ingredients

Enriched Wheat Flour

Tapioca Flour

Wheat Starch

Brown Sugar

Vegetable Shortening

Salt

Soy Lecithin

Vegetable Color

Baking Soda

Example 2

Sugar Baking Cups (for Cupcakes)

Ingredients

Enriched Wheat Flour

Brown Sugar

Sugar

Vegetable Shortening

Carmel Color

Salt

Corn Starch

Soy Lecithin

The formulations for the baking cups 10 have a neutral flavor, which in essence absorbs some of the flavor of the particular muffin batter. The formulation for the baking cups 10 intended for use with cupcake batter includes sugar to better withstand the more liquid cupcake batter.

The baking cup 10 may be produced by those means known in the art for forming ice cream cones, but the molding process would be adapted to form a baking cup 10 having the above-described characteristics.

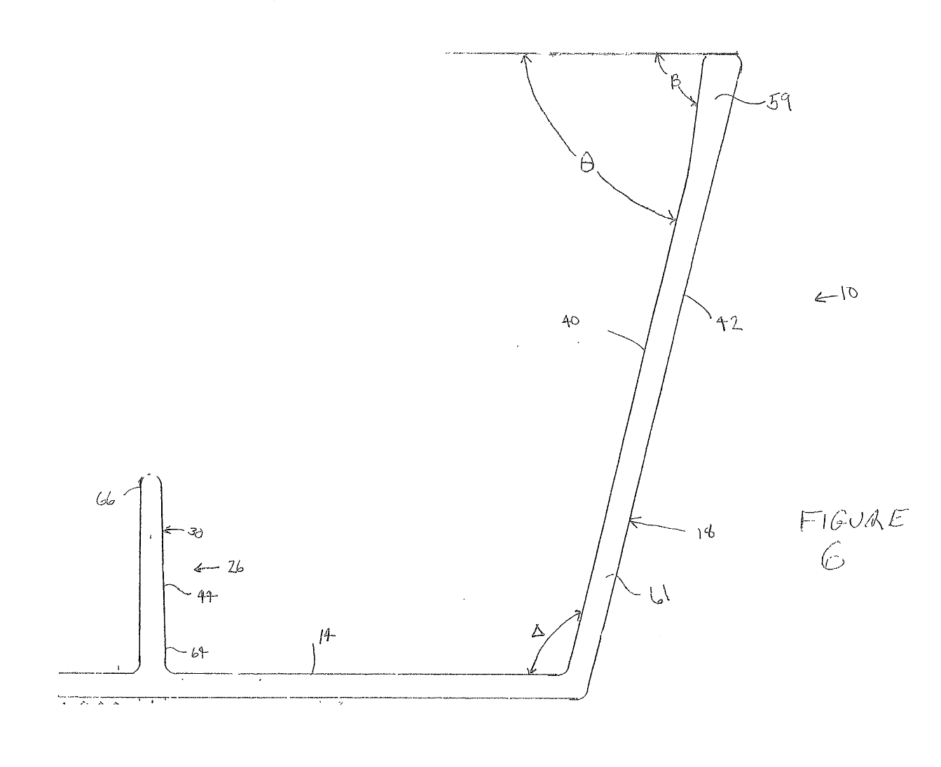

A second embodiment of the present invention is shown in FIGS. 5-8. In this embodiment, hard shell baking cups 10 are stackable in such a manner that the structure of the baking cups 10 does not crack or crumble when one particular baking cup 10 is removed from the rest of the column of stacked baking cups. The hard shell baking cups 10 comprise an angled side wall 18. The angled side wall 18 has an interior surface 40 and an exterior surface 42. The angle of the side wall is measured relative to the base 14. The side wall 18 of the hard shell-baking cup 10 comprises a tapered upper portion 59 and a substantially uniform bottom portion 61. The upper portion 59 is approximately the upper ⅜ inches of the side wall 18.

The side wall 18 has a first end 50 and a second end 52. The first end 50 is integrally formed with the base 14, and the second end 52 is oppositely disposed from the first end 50. The second end 52 may be rounded, but this is not required. This rounded second end 52 provides for a stronger structure and resists cracking and crumbling when the next stacked baking cup 10 is removed. The second end 52 of the side wall 18 and the interior surface 40 form a tapered portion of the side wall 18, which is best seen in FIGS. 5, 6, and 8. The exterior surface 42 of the side wall 18 has a substantially constant angle from the base 14 to the second end 52 of the side wall 18, whereas the interior surface 40 of the side wall 18 does not have a constant angle from the base 14 to the second end, which is described below.

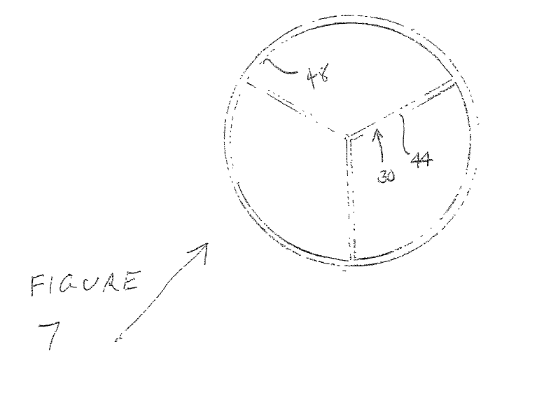

Turning to FIG. 6, an exploded view of the present invention is illustrated. The second end 52 of the side wall 18 forms a generally horizontal plane, which is substantially parallel to the planar base 14 of the baking cup 10. As shown in FIG. 6, the interior surface 40 of the side wall 18 forms an angle β measured between this horizontal plane and the interior surface 40 of the upper portion 59 of the side wall 18. In the preferred embodiment, β is substantially 84°. The lower portion 61 of the hard baking cup 10, which has a uniform thickness, comprises a second angle θ with the horizontal plane. In the preferred embodiment, angle θ is substantially 76°. As shown in the figures, β less θ should be no more than approximately eight degrees. An angle Δ is formed between the planar base 14 and the interior surface 40 of the lower portion 61 of the side wall 18. In the preferred embodiment, angle Δ is substantially 104 degrees. It is believed that these angles provide for a rigid construction of the baking cup 10 and yet provides for easy stacking with other baking cups. It is contemplated that these angles may deviate slightly, but should not deviate more than ten degrees, so that the hard shell baking cups 10 are easily removed from the die from which they are made.

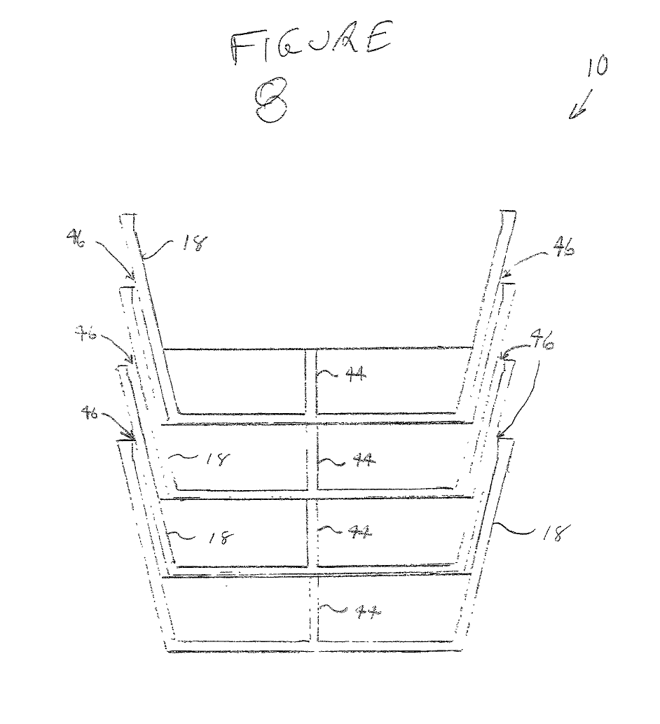

As shown in FIGS. 5-8, the second embodiment of the hard shell baking cups 10 also comprises the stacking structure 26 as previously described. As shown in FIG. 5, the hard baking cup 10 comprises the stacking structure 26 having a plurality of partial walls 30, which serve as stacking ribs 44 that extend from the base 14. As shown in FIG. 5, the stacking rib 44 is substantially ⅝″ high. In this embodiment, each stacking rib 44 is tapered such that it is slightly thicker where the stacking rib 44 interconnects with the planar base 14. As shown in FIG. 6, a bottom thickness 64 of the stacking rib 44 may be substantially 5/64 inches and a top thickness 66 of the stacking rib 44 may measure approximately 1/16 inches. It is believed that this stacking rib geometry provides for easy removal of the baking cup 10 from the mold die (not shown) without damaging the stacking rib 44. In this embodiment, it is preferred that three partial walls extend from the base 14. This number is sufficient to support the next baking cup that will be stacked therein. As shown in FIG. 7, the three partial walls 30 are connected at a central point of the base 14 and extend towards the peripheral edge 48. The three partial walls form substantially equal spaces therebetween. Of course, it is contemplated that the partial walls 30 be configured in any manner, such as but not limited to, a triangle shape.

Because of the stacking rib 44, the side wall 18 of one baking cup 10 and the side wall 18 of the next stacked baking cup 10 define a space 46 therebetween. In the preferred embodiment as shown in FIG. 8, the space 46 defined between the side wall 18 of one baking cup 10 and the side wall 18 of the next stacked baking cup 18 is substantially continuous. With the geometry described herein, the hard baking cups 10 can be easily stacked within each other, as shown in FIG. 8. As the baking cups 10 are stacked within each other, the interior surface 40 of the side wall 18 of one baking cup 10 does not contact the exterior surface 42 of the next stacked hard baking cup 10. The only point of contact between stacked baking cups 10 is between the stacking rib 44 of one hard baking cup 10 and the bottom of the planar base 14 of the next baking cup 10. Because there is no contact between the angled side walls 18 of stacked baking cups 10, the hard baking cups 10 can be easily removed for use. Upon removal of a baking cup 10 from the stack, no crumbling or cracking occurs, and the integrity of the product is maintained.

The invention has been described with reference to preferred embodiment. Obviously, modifications and alterations will occur to others upon a reading and understanding of this specification. It is intended to include all such modifications and alternations in so far as they come within the scope of the appended claims or the equivalence thereof.

Having thus described the invention, it is now claimed:

What is claimed is:

1. A baking cup for containing a batter during a baking process in which said batter forms a baked food item, said baking cup comprising:
a generally planar base having a peripheral edge; and,
a continuous upwardly extending side wall having a first end attached to said peripheral edge of said planar base and a second end oppositely disposed from said first end, said side wall further comprising an interior surface and an exterior surface, said base and said side wall defining an open interior space for receiving said batter, said baking cup adapted to be stackable with other baking cups, said exterior surface maintaining a substantially constant angle from said planar base to said second end, wherein said side wall does not contact the side walls of associated adjacently stacked baking cups.

2. The baking cup of claim 1 wherein said base is circular and said interior surface of said side wall is outwardly angled with respect to said base at an angle Δ, wherein said interior space comprises a generally increasing circular cross-section from said base to an upper region of said side wall.

3. The baking cup of claim 2, wherein said angle Δ is substantially 104 degrees.

4. The baking cup of claim 3, wherein said side wall comprises a tapered upper portion such that said interior surface of said tapered upper portion forms an angle β with a horizontal plane, said horizontal plane defined by said second end of said side wall, wherein said angle β is substantially 84 degrees.

5. The baking cup of claim 4, wherein said side wall comprises a lower portion, said interior surface of said lower portion having an angle θ, wherein said angle θ is less than angle β.

6. The baking cup of claim 5, wherein angle θ is substantially seventy-six degrees.

7. The baking cup of claim 1 further comprising:
a stacking structure attached to said base, said stacking structure adapted to support an additional baking cup placed in said interior space.

8. The baking cup of claim 7, wherein said stacking structure has a plurality of tapered stacking ribs.

9. The baking cup of claim 7, wherein said stacking structure comprises at least three tapered stacking ribs.

10. The baking cup of claim 9, wherein said three tapered stacking ribs are connected at a central point of said base and extend towards said peripheral edge of said planar base, said three partial walls forming substantially equal spaces therebetween.

11. A column of stacked baking cups, each of said baking cups comprising:
a generally planar base having a peripheral edge; and,
a side wall having a first end attached to said planar base and a second end oppositely disposed from said first end, said side wall further comprising an interior surface and an exterior surface, said base and said side wall defining an open space for receiving the next stacked baking cup, said side wall further comprising a tapered upper portion, and a lower portion with substantially uniform thickness, wherein said side wall of one baking cup and said side wall of the next stacked baking cup define a space therebetween.

12. The column of stacked baking cups of claim 11, wherein said space defined between said side wall of one baking cup and said side wall of the next stacked baking cup is continuous.

13. The column of stacked baking cups of claim 11, further comprising a plurality of tapered stacking ribs attached to said base for supporting the next stacked baking cup in said column.

14. The column of stacked baking cups of claim 13, wherein said plurality of stacking ribs is three.

15. The column of stacked baking cups of claim 11, wherein said base is circular and said interior surface of said side wall is outwardly angled, said second end defining a horizontal plane being substantially parallel to said base, said interior surface of said tapered upper section forming an angle β with said horizontal plane, and said interior surface of said lower portion forming an angle θ with said horizontal plane, wherein angle θ is less than angle β.

16. The column of stacked baking cups of claim 15, wherein said angle β is substantially eighty-four degrees.

17. The column of stacked baking cups of claim 15, wherein said angle θ is substantially seventy-six degrees.

18. The column of stacked baking cups of claim 15, wherein β lessθ is no more than substantially eight degrees.

19. The column of stacked baking cups of claim 11, wherein said tapered upper portion is approximately ⅜ inches.

20. A hard baking cup for containing a batter during a baking process in which said batter forms a baked food item, said baking cup comprising:
a generally planar and circular base having a peripheral edge;
a side wall having a first end attached to said planar base and a second end oppositely disposed from said first end, said side wall further comprising an interior surface and an exterior surface, said base and said side wall defining an open space for receiving the next stacked baking cup, said side wall further comprising a tapered upper portion, and a lower portion with substantially uniform thickness, said tapered upper portion being the upper ⅜ inches of said sidewall, wherein said side wall of one baking cup and said side wall of the next stacked baking cup define a space therebetween;
a stacking structure attached to said base, said stacking structure adapted to support an additional baking cup placed in said space, said stacking structure comprising at least three tapered stacking ribs, said three stacking ribs being connected at a central point of said base and extending towards said peripheral edge of said planar base, said three stacking ribs forming substantially equal spaces therebetween;
said interior surface of said upper portion of said side wall being angled with respect to said horizontal plane at an angle β, said angle β being substantially eighty-four degrees;
said interior surface of said side wall being angled with respect to said horizontal plane at an angle θ, wherein θ is substantially seventy-six degrees;
said interior surface of said lower portion of said side wall forming an angle Δ being outwardly angled with respect to said base, Δ being substantially 104 degrees; and,
said space comprising a generally increasing circular cross-section from said base to said upper portion of said side wall.
